(19) United States
(12) Patent Application Publication
(10) Pub. No.: US 2004/0072561 A1
(43) Pub. Date: Apr. 15, 2004

(54) Direct-to-home-and-mobile satellite internet service

(76) Inventor: James Nicholas LaPrade, Pleasanton, CA (US)

Correspondence Address: J. E. Kosinski, Loral Space & Communications Ltd., Suite 303, 655 Deep Valley Drive, Rolling Hills Estates, CA, 90274, US

(21) Appl. No.: 10/272,253

(22) Filed: Oct. 15, 2002

(51) Int. Cl. H04Q 7/20

(52) U.S. Cl. 455/427; 455/430; 455/436; 455/429

(57) ABSTRACT

The present invention integrates a direct-to-home satellite Internet service with a mobile broadcast service via a hand-held caching terminal that accesses multiple return-link paths through the available cellular infrastructure or through the satellite to the Internet and to a home-PC-based server.

### I. FIELD OF INVENTION

This invention relates to communications satellite systems and services and, more particularly, to a direct-to-home-and-mobile satellite internet service (hereinafter referred to DTHM).

### II. PRIOR ART

Satellite based communications systems operating at high data rates are known in the prior art as described in U.S. Pat. No. 6,339,707B1 issued Jan. 15, 2002 to S. Lynne Wainfan, et al entitled “Method and System for Providing Wideband Communications to Mobile Users in a Satellite-Based Network”. These systems include “a plurality of satellites, each having uplink and downlink antennas for transmitting and receiving a plurality of signal utilizing a plurality of spot beams as signals; utilizing a plurality of spot beams to and from a plurality of coverage areas at a predetermined range of frequencies. The system also includes a plurality of user terminals for transmitting and receiving signals to and from the plurality of communications satellites at the predetermined range of frequencies and at one of the first plurality of data rates. Each of the user terminals having a steerable antenna for tracking relative movement of each of the user terminals with respect to each of the plurality of communications satellites are for tracking movement of each of the plurality of communications satellites in order to maintain communications with the plurality of communications satellite.”

In U.S. Pat. No. 6,032,041 issued Feb. 29, 2000 to S. Lynne Wainfan et al, entitled “Method and System for Providing Wideband Communications to Mobile Users in a Satellite-Based Network”, a variant of the system as described in the '707B1 patent to Wainfan et al is described.

In U.S. Pat. No. 6,105,060 issued Aug. 15, 2000 to Martine A. Rothblatt, entitled “System for Providing Global Portable Internet Access using Low Earth Orbit Satellite and Satellite Direct Radio Broadcast System”, “a system for providing global and portable Internet access to low cost user terminals comprises an Internet service provider gateway and a broadcast station for providing multimedia information from the gateway to the user terminal via a direct radio broadcast geostationary satellite” is disclosed. “User terminals [are provided which] each comprise a direct radio broadcast receiver and a transceiver for communicating with a low earth orbit (LEO) satellite. User terminals transmit Internet access requests, menu selections and other backhaul signals to the gateway via the transceiver. The broadcast station transmits information requested by the user from the gateway to a specific user terminal by providing identification codes in the broadcast programs. The user terminals are programmable to receive all broadcast programs but to demodulate and multiplex only those broadcast channels addressed to the user terminal. Internet access is available simultaneously with reception of satellite direct broadcasts of audio programs.”

In U.S. Pat. No. 5,963,862 issued Oct. 5, 1999 to Adi R. Adiwoso et al, entitled “Integrated Telecommunications System Providing Fixed and Mobile Satellite-Based Services”, there is disclosed “an integrated telecommunications system [which] provides fixed and mobile satellite-based services via one or more geosynchronous satellites. Two-way user links are provided by the satellites to user terminals located throughout a geographical region. Additionally, the satellites provide two-way access links to gateway stations within the region, and also to a satellite network control center. The network control center controls bandwidth and power of the satellites to establish the user links and the access links. A mobile cellular telephone network provides mobile cellular telephone service to a subscriber that also has a user terminal. A gateway station includes a gateway station controller coupled to a mobile switching center, which, in turn, is coupled to a terrestrial network. The gateway station controller provides control signals [to] route calls to either the user terminal to the mobile cellular telephone of the subscriber based on a signal dialed number.”

In U.S. Pat. No. 6,160,994 issued Dec. 12, 2000 to Robert A. Wiedeman, entitled “Interactive Fixed and Mobile Satellite Network”, there is described “a communications system [which] includes at least one second satellite (11) in other than a low earth orbit, and a ground segment (12) that includes a plurality of user transceivers (78, 80, 82, 84) and at least one gateway (76) coupled to a publicly-accessible terrestrial communications system, such as a PSTN and/or a fiber optic network. The first satellite includes a first transceiver for communication with the at least one gateway, a second transceiver for communication with at least one user transceiver, and a third transceiver for communication with the at least one second satellite. The first, second and third transceivers are switchably coupled together on-board the first satellite by on-board processors, and a switching matrix for relaying a user communication between the at least one gateway and the at least one user transceiver via the at least one second satellite. The plurality of user transceivers can include a plurality of data processors which are interconnected into a network through the at least one first satellite. This network can be considered as a virtual network, and can have a mesh, star, or other topology. The user transceivers can be adapted to transmit and receive direct sequence, code division/multiple access communications. Transmission of signals to and from the user transceivers is accomplished by spreading a digital data stream (e.g., voice, data, image, video) with assigned spreading codes.”

None of the above prior art is directed to a DTHM as provided in the system of the instant invention. Wainsan et al ('707B1 and '041) require a LEO plus GEO satellite combination, a full deployment and tracking antenna to enter service limiting regional roll out to await full global deployment as do Wiedeman ('994) and Rothblatt ('060). Adiwoso ('862) provides for a gateway interface to the PSTN for cellular phone services but does not provide Internet access.

### III. OBJECTS OF THE INVENTION

There is, therefore, a demonstrated need to provide a novel DTHM system devoid of the above recited deficiencies.

It is a further object of this invention to provide a DTHM system which comprises a novel geostationary satellite (GEO) which combines communications payloads for mobile services and DTHM services to enable a mobile personal terminal to interact with a desktop server either through a wireless local or metropolitan network (hereinafter referred to as LAN/MAN) or through a satellite gateway.

It is a further object of this invention to provide a DTHM system which comprises a novel geostationary satellite providing voice over Internet protocol (hereinafter referred to as VoIP), two-way video and Internet access through both a mobile device and a desktop server.

Still another object of this invention is to provide a DTHM system which comprises a novel gateway system having hand-off capability between two signals that simultaneously transmit the user information wherein the first beam moves off a user and the second beam moves onto said user.

Still another object of this invention is to provide a DTHM system wherein a novel gateway system is provided which has the capability of utilizing a greater number of receive beams than transmit beams illuminating a user coverage area.

Yet still another object of this invention is to provide a DTHM system which provides a novel data terminal and caching system for home and mobile use.

Yet another object of this invention is to provide a DTHM system wherein a novel data terminal and caching system is provided which enables a single satellite to combine three communication payloads; a mobile broadcast, two-way mobile data and direct-to-home data service.

Still another object of the invention is to provide a novel DTHM system which provides a unique combination of services provided with a single satellite/gateway configuration.

Yet again another object of this invention is to provide a DTHM system which comprises a multi-band, multifunctional payload that combines the direct-to-home Internet data service provision with broadcast service provision over a common coverage area for providing a variety of integrated service offerings that involve a hand held user terminal linked to a home PC server.

These and other objects of the instant invention are accomplished generally speaking by providing a DTHM system which has the capability of integrating services by a unique combination of communication satellite payloads aboard at least a single spacecraft and at least a single Internet-connected gateway that delivers broadcast content, Internet connectivity, and home server access to mobile users.

### IV. SUMMARY OF THE INVENTION

Thus, there is provided at least a single satellite and gateway system to deliver a multiplicity of integrated mobile services including: telephony, real time video/audio/data broadcast reception, data caching, home server access, Internet access, packet data relay, two-way video and, eventually, “augmented reality” interactions. Thus, for example, a single communications satellite is provided including a payload with a multiband functionality that is complimentary to system operations from a single gateway that provides regional coverage through access to that satellite. This notably overcomes the prior recognized deficiencies in the prior art which include limited services offerings, higher implementation costs and global deployment requirements before initiating service. A hand held user terminal is provided that receives satellite broadcasts and transmits through a variety of LAN/MAN paths such as, for example, with IEEE 802 LAN/MAN standards for wireless networking, cellular networks and a satellite, depending on the data rate requirements and access. In this system the mobile terminal cache links the user to the home PC.

There is provided a satellite system that provides multiple services to customer mobile hand held terminals and to customer home PCs using, for example, a single Internet connected gateway and a single satellite with multiband, multifunctional payload. The hand held terminal link to a desktop server is maintained through local wireless networks or regional cellular networks or through the satellite depending on the data rate, Quality of Service (hereinafter referred to as QoS) and access. The capabilities of the hand held terminal include receiving satellite broadcasts emanating from the gateway, caching various data for future access, displaying real time or cached video programming, delivering audio programming, providing telephony over the Internet, accessed either through the gateway or the home server. The gateway provides two-way Internet service to the home PC server broadcast of programming which may be augmented with ground based repeaters receiving satellite relay broadcasts, and the interconnection of the mobile user terminal to the home PC server through the most cost effective and available means, including through the satellite.

The system of the instant invention delivers a range of mobile and direct-to-home services through, for example, a single satellite/gateway/Internet architecture that is enabled by a mobile user terminal linked through the satellite and terrestrial wireless means to the customer's home PC server. The mobile user terminal, for example, receives and caches broadcast content from the gateway through the satellite. An Internet connection may be established through the satellite via the gateway or through the customer's home PC server; through satellite link to the gateway or an alternate connection to the PC such as Advanced Digital Subscriber Line (hereinafter referred to as ADSL) or cable modem among others. A similar communications payload is configured as a multi-band assemblage such as, for example, bent pipe repeaters and antennas to comprise a multifunction capability to deliver data services directly to customer premises and simultaneously deliver a variety of related broadcast and data services to the mobile user terminal.

The novel satellite of the instant invention may function with any suitable gateway or mobile user terminal other than the novel gateway and mobile user terminal recited above. Typical gateways include: satellite teleports for cable content distribution, PSTN connected mobile satellite service gateways and direct-to-home (DTH) video broadcast gateways among others.

Typical mobile user terminals include: cell phones, wireless interactive, personal digital assistant (PDA) for example, Palm Pilot and mobile satellite phones among others.

Most preferably the novel satellite of the instant invention is optimally employed with the novel gateway and novel mobile user terminal as recited above to provide the preferred DTHM system of the instant invention.

The novel gateway of the instant invention may be employed with any suitable satellite or mobile user terminal other than the novel satellite and novel mobile user terminal recited above. Typical satellites include: C/Ku-band hybrid fixed service satellites, S-band mobile satellites and Ku-band direct broadcast satellites among others.

Although the DTHM system of the instant invention has been defined in general terms with regard to the geostationary satellite, gateway and hand held capability that it provides, the system of the instant invention will be more clearly understood from the following description of the drawings.

### V. BRIEF DESCRIPTION OF THE DRAWINGS

FIG. 1 depicts the general system of the instant invention.

FIG. 2 depicts a preferred embodiment of the instant invention.

### VI. DETAILED DESCRIPTION

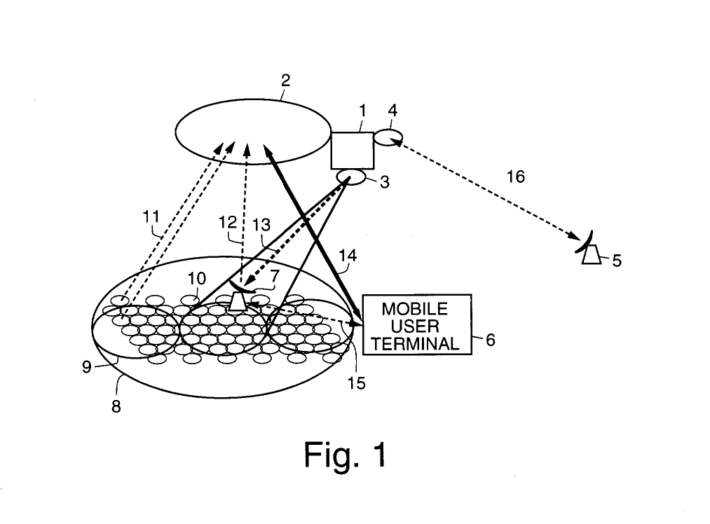

In FIG. 1 there is seen a satellite (1) positioned in geostationary orbit with several frequency bands represented by reflector antennas (2, 3, and 4). The satellite provides various communication services to and between users within its coverage area using the gateway (5) and the mobile user terminal (6) that is connected through various paths to the home PC server (7) within the satellite coverage area (8). Multiple frequency bands may be combined within each satellite reflector antenna. All communications through the system to outside the satellite coverage area are facilitated through the gateway. The mobile terminal communicates directly with other mobile terminals and to the home PC server through various wireless means including for example, IEEE 802 LAN/MAN standards for wireless networking, various regional cellular systems and through the satellite/gateway arrangement.

Multiple frequency bands are used by the satellite to provide the various services into the region. The total coverage region (8) is defined by the mobile broadcast beam that delivers the audio/video/data broadcast services to the user's home PC server (7) and also to their mobile user terminal (6). An overlapping set of antenna beams for related services is also shown. The broadband DTHM services are represented in the figure by two sets of antenna coverage beams. Broadband Internet service from the gateway is provided to the user's home PC server (7) on the forward link beam (9) while transmissions from the user's home PC server (7) are received by the satellite from one of the contiguous beams (10). Frequency reuse (4×) (not shown) is depicted by the four different colors (green, red, blue and gray) used to designate the beam. Multiple simultaneous broadband service user uplink (return) transmission (11) like that from the user's home PC server (12) are received by the satellite (1) and transmitted to the gateway (5). A different frequency reuse is depicted on the forward broadband link (13). In this case, the forward link beam covers the same area as a large number of the return link receive beams. A two-way data link, and a separate broadcast link to the mobile user terminal are both accomplished through path (14). In addition, a two way data link may be separately established between the mobile user terminal and the home PC server via one, or several, wireless links that involve a local protocol such as for example, IEEE 408 standards for wireless LAN/MAN or a regional cellular telephony/data system (15). All information delivered to the user through the satellite is delivered via a single link (16) that will typically be in a higher frequency band than signals in the other links (11, 12, 13, 14) to provide sufficient bandwidth to encompass the bandwidth needs of those separate and combined services.

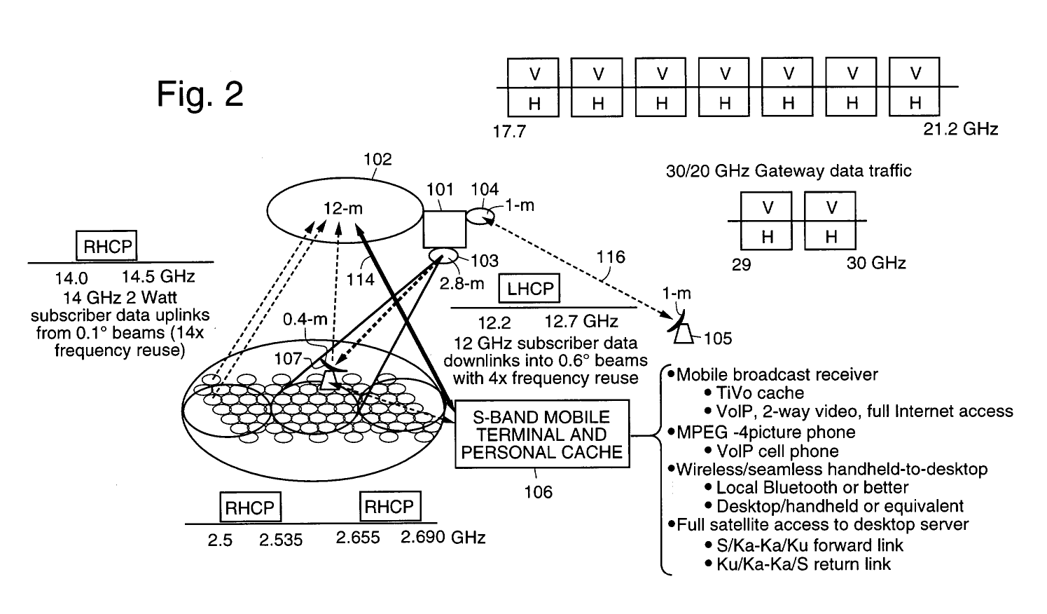

In FIG. 2 there is seen a DTHM system which offers through a single satellite payload (101) that combines different frequency bands and shares reflector antennas (102, 103 and 104) between different services (frequencies) to achieve efficient operation. One service is, for example, the Ku/Ka-band DTHM Internet service that transmits data on the forward link in the, for example, 12 GHz frequency band from the, for example, 2.8-meter (m) (103) antenna, and receives data from the user's home PC server (107) in the, for example, 14 GHz frequency band from the 12-m antenna. An independent service is provided by the two-way beam (114) to the mobile user terminal (106) from the 12-m antenna (102). Another broadcast service is delivered in a separate frequency band that also uses the, for example, 12-m antenna (102). Traffic between the gateway (105) and the satellite (101) is all carried within the 30/20 GHz frequency bands (116) which enables a small antenna aperture at the gateway (105).

Combined service offerings include, but are not limited to: audio and video broadcast to mobile and home receivers (both real time and for storage in the cache), data broadcasting to mobile and home caches, Internet access from home or the mobile user terminal, two-way voice and video from mobile user terminal to another mobile user terminal over the Internet, combined operation of mobile user terminal and home PC server in client-server arrangement, interactions and exchanges associated with future augmented reality related services, gateway derived value-added content and processing applied through the service infrastructure.

Although the system of the instant invention has been described in terms of the specification and drawings, the improvement which it provides to prior art systems may be more clearly understood by examining existing satellite services which include DTHM video broadcasting and Digital Audio Radio Services (DARS) as well as direct-to-home two-way Internet services. Each prior art embodiment employs a unique variety of communications satellite payload and gateway interactions to deliver a variety of prior art services. The integration of multiple payloads onto a single satellite platform as in the instant invention and the integration of the combination of services into a single gateway as provided in the system of the instant invention represents a vast improvement over said prior art systems. It affords the provision of independent services independently facilitated by each of the payloads and the central gateway which allows various bundling of service offerings. As the variety of consumer devices becomes available to integrate various features of the various independent services, the service provider is positioned to address new market opportunities as they develop. A more specific example is the provision of a DTHM two-way Internet service that stands alone and apart from the direct broadcast of audio and video programming to mobile user terminals while the two-way voice and image service to the mobile user terminal is a separate and completely stand-alone service from the other two. These services may be combined to allow for mobile Internet access, the caching of broadcast contents onto mobile and home equipment, and their interactive possibilities providing a large variety of combined service offerings which better defines the broad sweep of the DTHM system of the instant invention.

Although the DTHM system of the instant invention has been defined in terms of the specifications, drawings and examples above, it is understood that those skilled in the art would understand and include combinations, permutations, modifications and enhancements of the system of the instant invention without departing from the spirit of the instant invention defined by the appended claims.

In particular, all combinations of broadcast and two-way interactive services, both real time and cached, involving the Internet, the mobile user and the mobile user's home PC server are within the scope of the instant invention. The services are provided through a single satellite or single collection of satellites at a single location in the geostationary arc and a single gateway or single collection of gateways that include redundancy coupled in an integrated manner.

Also, measures taken to enhance the reliability of the invention such as site diversity for multiple gateways and the collocation of back-up satellites on-orbit that provide higher overall availability are included in this invention of a single-multiband-satellite-through-single-gateway communications services architecture.

What is claimed is:

1) A direct-to-home-and-mobile satellite internet service system comprising:
a) a hand held mobile terminal comprising a large data cache with two way communication links comprising a local link and a satellite link to a user's server,
b) a gateway providing two way communication from the hand held mobile terminal to the server and
c) a geo satellite providing two way communication and mobile broadcast services through the gateway.

2) The system as defined in claim 1 wherein said server comprises a personal computer.

3) A direct-to-home-and-mobile satellite internet service system comprising:
a) a hand held mobile terminal
b) a gateway providing two way communication from the hand held mobile terminal to a server and
c) a geo satellite comprising a combination of payload elements providing two way communication and mobile broadcast through the gateway.

4) The system as defined in claim 3 wherein said server comprises a personal computer.

5) A direct-to-home-and-mobile satellite internet service system comprising:
a) a hand held mobile terminal
b) a gateway comprising a user monitor which tracks a transmit beam to provide hand-off between two transmit signals when a first beam moves off the user and a second beam moves on to said user, and
c) a geo satellite providing two way communication and broadcast through the gateway.

6) The system as defined in claim 3 above wherein the gateway comprises a large antenna which provides smaller spot beams employing a large degree of frequency.

7) The system as defined in claim 3 above wherein said gateway employs a greater number of receive beams than transmit beams illuminating a user coverage area.

8) The system as defined in claim 3 above wherein said transmit and receive beams are separated into two antennas.

9) A direct-to-home-and-mobile satellite internet service system comprising:
a) a geostationery communications satellite comprising a multi-band payload
b) a gateway with Internet point-of-presence providing a multiplicity of services, and
c) a mobile user terminal which receives broadcasts from said satellite and communicates through terrestrial wireless systems or satellite to the gateway and a server.
